(19) United States
(12) Patent Application Publication
(10) Pub. No.: US 2004/0075717 A1
(43) Pub. Date: Apr. 22, 2004

(54) Wafer processing apparatus and method

(76) Inventors: Seamus O'Brien, Castleblayney (IE); Aidan Corcoran, Lucan (IE)

Correspondence Address: HEWLETT-PACKARD COMPANY, Intellectual Property Administration, P. O. Box 272400, Fort Collins, CO, 80527-2400, US

(21) Appl. No.: 10/273,381

(22) Filed: Oct. 16, 2002

(51) Int. Cl. B41J 2/14; B23K 26/36

(52) U.S. Cl. 347/71; 219/121.72; 219/121.67; 347/47

(57) ABSTRACT

A method of dicing a wafer into a plurality of dies is disclosed. The wafer comprises a substrate having a surface on which at least one thin film layer is formed. The method comprises the steps of laser cutting a plurality of lines in the wafer to at least the depth of the at least one thin film layer; and saw cutting along the plurality of lines in the wafer to dice the wafer.

### FIELD OF THE INVENTION

The present invention relates to a method and apparatus for processing a wafer.

### BACKGROUND OF THE INVENTION

Various inkjet printing arrangements are known in the art and include both thermally actuated printheads and mechanically actuated printheads. Thermal actuated printheads tend to use resistive elements or the like to achieve ink expulsion, while mechanically actuated printheads tend to use piezoelectric transducers or the like.

Referring to FIG. 1, which shows a plan view of a representative thermal inkjet print head comprising a semiconductor substrate 10 on which a plurality of thin film layer resistors are provided obverse the surface shown. Further orifice and/or barrier layers (not shown) are provided on the substrate to define firing chambers about each of the resistors, an orifice corresponding to each resistor, and an entrance to each firing chamber. Actuation of a heater resistor by a “fire signal” causes ink in the corresponding firing chamber to be heated and expelled through the corresponding orifice. Ink is typically provided at the entrance of a firing chamber through an associated feed slot 12 (one for each color) that is machined in the semiconductor substrate. The substrate usually has a rectangular shape, with the slot(s) disposed longitudinally therein.

Conventionally an array of such printheads is fabricated on a wafer substrate. Once the above thin film layers have been fabricated and slot/chamber machining has been performed, the wafer is diced to provide individual printheads, which are then mounted on print cartridges. The sets of parallel and transverse lines corresponding to the edges of the dies along which the wafer is diced are referred to as streets and a typical wafer may have in the region of 12 meters of streets, which need to be processed to completely dice the wafer.

A conventional method of dicing wafers in chip manufacturing applications comprises cutting the wafer with a rotating saw blade. However, the thin film layers even though they are typically around 3 μm in depth have long caused problems in wafer dicing because they attach to and load the edge of the cutting blade. Loading causes several problems including chipping on both the blade-facing surface of the wafer and surface of the wafer obverse the blade indicated by the numerals 14. This chipping and resultant sharding increases failure rates and often leads to crack propagation within the wafer and/or die substrate. Also blade loading tends to cause blade breakage.

An improved wafer cutter is manufactured under Model Number DF651 by Disco Corporation, Tokyo, Japan. Referring to FIG. 2, the Disco saw has 2 blades 20, 22 and in step cutting mode, the blades travel along the streets of a wafer 24 in tandem in the direction indicated by the arrow 26. The leading blade 20 removes the thin film layers 28 described above and the trailing blade 22 dices the wafer. In order to maintain the cut portions of the wafer in alignment during the dicing process, the wafer is first mounted on a UV curable tape (not shown) typically 50-100 μm thick with the thin film layers on the surface obverse the tape. This tape is in turn stretched over a metal bracket before being mounted in the wafer cutter. The depth of cut of the blade 22 is set to cut through the substrate but only to contact the tape, so that even when the streets have been cut in one direction, the entire wafer may be rotated 90° to have the transverse streets cut. The step cutting process thus prevents the thin film layers 28 attaching to the second blade 22. It should be noted that a typical process speed for such step cutting is 80 mm/sec and this significantly limits the capability of the dicing process.

An alternative method for wafer dicing is disclosed in U.S. Pat. No. 6,257,224, NGK. This discloses laser-scribing grooves corresponding to streets in a wafer prior to manually cleaving the wafer along the grooves. This manual cleaving process is clearly not suitable for large-scale automation and so for commercial applications. Also the cleaving process requires pressure to be brought to bear on the thin film layers of the wafer, so risking damage to these structures.

A further alternative to saw cutting a wafer is laser dicing, FIG. 3. Here a laser beam 30 is used exclusively to machine the streets. However, this technique is only suitable for thin silicon wafers where there are no high aspect ratios i.e. kerf-width (x) to cut-depth (z), which would adversely affect the laser cutting process. This is because high aspect ratio cutting causes difficulties in debris removal, which in turn causes blocking of the laser beam 30 from the cut front 32 with trapped plasmas and debris. Also, complete laser dicing of thick (675 μm) silicon wafers, which would typically operate at speeds less than an order of 10 mm/sec, is extremely slow in comparison to a saw based process.

### SUMMARY OF THE INVENTION

The present invention comprises a method of dicing a wafer according to claim 1. Further aspects of the invention include apparatus for dicing a wafer and a die produced according to the processing method of claim 1.

The invention allows an increase in wafer dicing throughput with negligible use of laser machine tool capacity and the possibility of gaining a reduction in street width.

### BRIEF DESCRIPTION OF THE DRAWINGS

FIG. 1 illustrates a printhead processed according to a prior art dicing process;

FIG. 2 illustrates a prior art saw cutting process;

FIG. 3 illustrates a prior art laser cutting process;

FIG. 4 is a perspective view of a printer for printing on media with a print cartridge;

FIG. 5 is a perspective view of the cartridge of FIG. 4 with a printhead of an embodiment of the present invention;

FIG. 6 illustrates a perspective view of one embodiment of a printhead;

FIG. 7 illustrates a cross-sectional view of an embodiment of a printhead of FIG. 5;

FIG. 8 illustrates a laser machining process for an embodiment of the present invention;

FIG. 9(a) and (b) illustrate a saw cutting process for an embodiment of the present invention;

FIGS. 10(a) and 10(b) are a photograph and a scanning electron microscope (SEM) image respectively of a printhead processed according to a prior art single blade cutting process;

FIGS. 11(a) and 11(b) are a corresponding photograph and a SEM image respectively of a printhead processed according to a preferred embodiment of the present invention; and

FIG. 12 is a more detailed SEM image of the printhead of FIG. 11(b) in reverse.

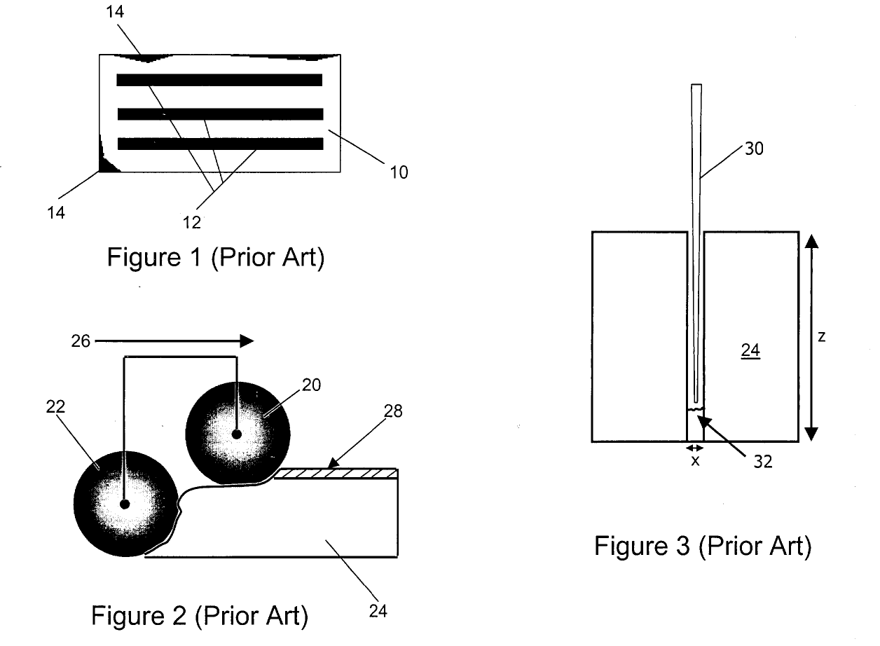

### DETAILED DESCRIPTION

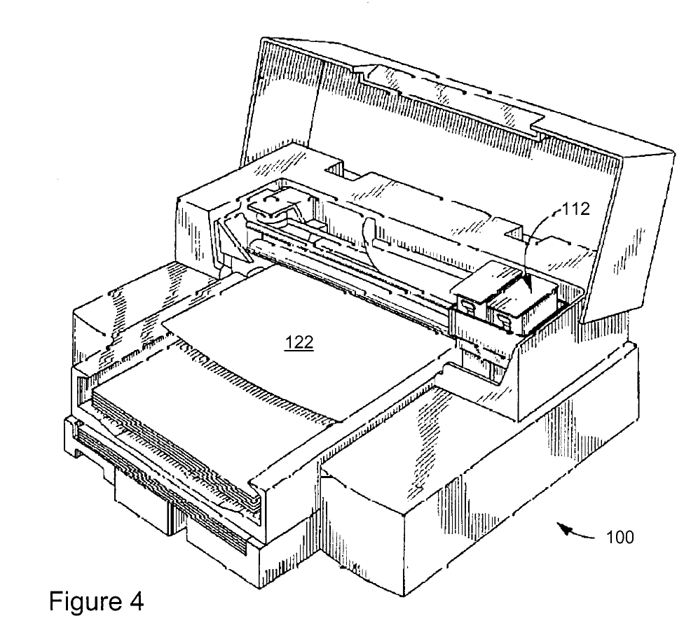

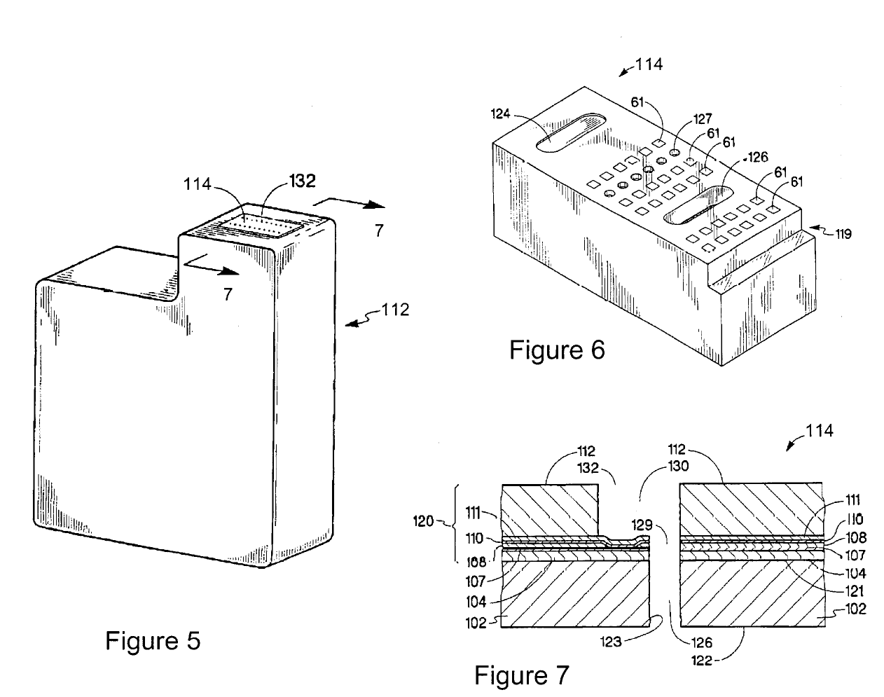

FIG. 4 is a perspective view of a printer 100 for printing on media 122 with a print cartridge (or ejection cartridge) 112 and FIG. 5 is a perspective view of the cartridge 112 with a printhead (or fluid drop generator or fluid ejection device) 114 of an embodiment of the present invention Fluid or ink is ejected or fired out from nozzles 132 to the media 122.

FIG. 6 illustrates an enlarged view of one embodiment of the printhead 114 in perspective view. The printhead 114 in this embodiment has multiple features, including an edge step 119 for an edge fluid feed to resistors (or fluid ejectors) 61. The printhead also has a trench 124 that is partially formed into the substrate surface. A slot (or channel) 126 for a slot fluid feed to resistors 61, and/or a series of holes 127 feeding fluid to resistors 61 and/or the trench 124 are also shown on this printhead, each being formed by a UV laser machining process as described in co-pending application Ser. No. 10/138,594 filed 2 May 2002 (Attorney Docket No. 10019334-2). In one embodiment there are at least two of the features described on the printhead 114 in FIG. 6. For example, only the feed holes 127 and the slot 126 are formed in the printhead 114, where in an alternative embodiment the edge step and/or the trench 124 are formed as well. In another example, the edge step 119, and the slot 126 are formed in the printhead 114, where in an alternative embodiment the trench 124 and/or the feedholes 127 are formed as well.

FIG. 7 illustrates a cross-sectional view of the printhead 114 of FIG. 5 where the slot 126 having slot (or side) walls 123 is formed through a substrate 102. A thin film layer (or an active layer, a thin film stack, an electrically conductive layer, or a layer with microelectronics) 120 is formed or deposited on a front or first or surface 121 of the substrate 102. The first surface 121 of the substrate is opposite a second surface 122 of the substrate 102. The thin film stack 120 is at least one layer formed on the substrate, and, in a particular embodiment, masks at least a portion of the first surface 121 of the substrate 102. Alternatively or additionally, the layer 120 electrically insulates at least a portion of the first surface 121 of the substrate 102.

As shown in the embodiment of the printhead shown in FIG. 6, the thin film stack 120 includes a capping layer 104, a resistive layer 107, a conductive layer 108, a passivation layer 110, a cavitation barrier layer 111, and a barrier layer 112, each formed or deposited over the first surface 121 of the substrate 102 and/or the previous layer(s). In one embodiment, the substrate 102 is silicon. In various embodiments, the substrate is one of the following: single crystalline silicon, polycrystalline silicon, gallium arsenide, glass, silica, ceramics, or a semi-conducting material. The various materials listed as possible substrate materials are not necessarily interchangeable and are selected depending upon the application for which they are to be used. In this embodiment, the thin film layers arc patterned and etched, as appropriate, to form the resistors 61 in the resistive layer, conductive traces of the conductive layer, and a firing chamber 130 at least in part defined by the barrier layer In a particular embodiment, the barrier layer 112 defines the firing chamber 130 where fluid is heated by the corresponding resistor and defines a nozzle orifice 132 through which the heated fluid is ejected. In another embodiment, an orifice layer (not shown) having the orifices 132 is applied over the barrier layer 112. An example of the physical arrangement of the barrier layer, and thin film substructure is illustrated at page 44 of the Hewlett-Packard Journal of February 1994. Further examples of ink jet printheads are set forth in commonly assigned U.S. Pat. No. 4,719,477, U.S. Pat. No. 5,317,346, and U.S. Pat. No. 6,162,589. In an alternative embodiment, at least one layer or thin film layer is formed or deposited upon the substrate 102. Embodiments of the present invention include having any number and type of layers formed or deposited over the substrate, depending upon the application for which the slotted substrate is to be utilized.

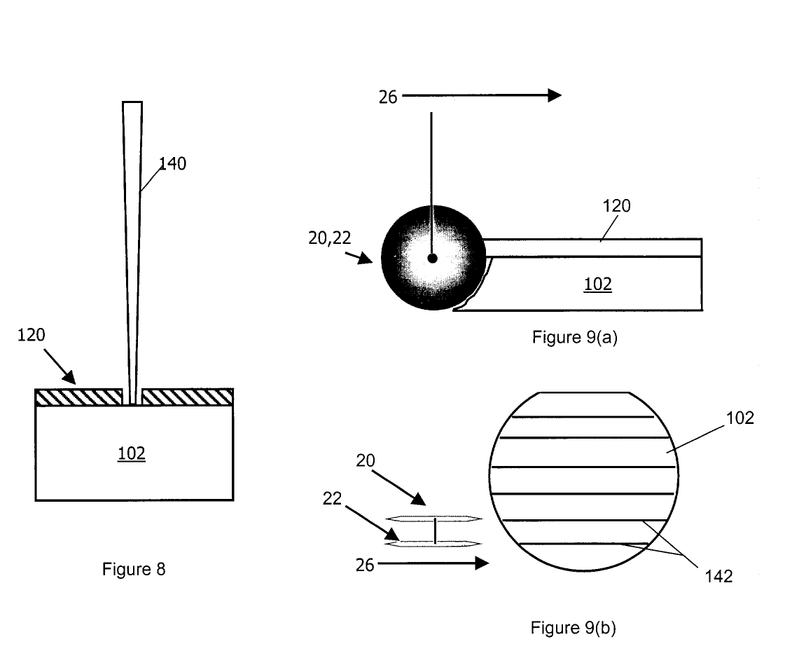

In a first embodiment of the present invention, a dicing process for a wafer including for example, printheads such as are described above comprises the steps of: laser cutting the streets of a wafer 102 to at least the depth of the thin film layers 120, FIG. 8; followed by saw cutting the streets of the wafer 102 to dice the wafer, FIGS. 9(a) and (b).

In this embodiment, the laser cutting process removes the thin-film layers 120 of the streets by cutting to a depth of approximately 20 microns, although it is desireable to reduce this depth to only slightly more than the depth of the thin film layers 120 to maximise laser processing throughput. In this embodiment, laser cutting of the streets can take place immediately after the cutting of the slots 126 has been completed, The laser machining is provided by a UV laser beam 140 (FIG. 8), and in one particular embodiment, is provided by a diode-pumped solid-state pulsed UV laser. In another particular embodiment, the UV laser 140 originates from a Xise 200 Laser Machining Tool, manufactured by Xsil of Dublin, Ireland. A laser source (not shown) uses power in the range of about 2 to 100 Watts, and more particularly about 4.5 Watts. The laser beam has a wavelength of (1060 nm)/n or (1053 nm)/n, where n=2, 3 or 4. In a specific embodiment, the UV wavelength is less than about 400 nm, in particular about 355 nm. The pulse width of the laser beam is about 15 ns in this embodiment, and the repetition rate is about 30 kHz. The laser beam has a diameter of about 5 to 100 microns, and more particularly about 30 microns in this embodiment. In an embodiment that is not shown here, the laser-machining tool of the present invention has a debris extraction system to remove the debris resulting from the laser machining. Using such a laser-machining tool, the streets of the wafer can be etched at a rate in excess of 166 mm/s which corresponds to approximately 1 minute per wafer

In an alternative embodiment, the step of laser cutting the streets of the wafer can be integrated with the step of cutting the slots 126 in the wafer. Typical dimensions for the slots 126 are 8 mm×150 μm. To achieve the required depth and resolution of cut for the slots, the laser machining tool described above removes 30 layers of material and so the approximate laser processing time for a complete wafer is 6 hours. Given the laser processing time mentioned above to etch the streets, it will be seen that the removal of the thin film layers from the streets for the dicing process consumes less than 1% of the laser machining tool capacity when machining the slots 126. As such it will be seen that the invention is particularly advantageously employed for dicing wafers where extensive laser processing is normally performed in producing the individual dies of the wafer as it can be integrated with this process without incurring significant processing overhead.

In both of the laser processing embodiments described above, it will also be seen that where any laser processing is normally employed in producing the individual dies of the wafer no re-tooling will be required to implement this aspect of the invention.

In a preferred embodiment of the invention, the step of laser cutting the streets of a wafer is followed by the step of completely dicing the wafer with a saw cutting machine. In a particularly preferred embodiment, the saw cutting machine is Model Number DF651 produced by Disco Corporation, Tokyo, Japan mentioned above. It will be seen that because the thin film layers 120 have been removed from the streets, there is no longer a need to employ a step cut. The machine may therefore be set in dual-cut mode where the 2 blades 20, 22 are offset so that they are side by side when cutting streets 142, FIG. 9(b). The provides a 100% increase in saw cutting throughput (excluding non-machining time) as twice as many streets may be processed at the same time as with the same machine operating in step cut mode.

Thus, when combined with implementing the laser cutting of the streets during slot cutting, this particularly preferred embodiment provides a 100% increase in throughput with reduced chipping and minimal use (<1%) of laser capacity.

In a further alternative embodiment, the invention is implemented in a single dicing machine equipped with both a laser source and a saw cotter of the types described above. This embodiment is particularly useful in situations where laser processing may not normally be employed in producing the individual dies of the wafer. The laser beam is focussed ahead of the cutting blade and removes the thin film layers 120 from the streets of a wafer just before the blade completely cuts through the wafer. As mentioned above, the laser source can operate at speeds in the region of 166 mm/s and the Disco cutting machine can operate at speeds of up to 150 mm/s. Thus, the laser machining step does not comprise a bottleneck in the wafer dicing process. In fact, if a sufficiently powerful laser source is available, the beam may be split to lead two saw cutting blades operating in the dual mode described above. It will be seen that given the available cutting speed of 150 mm/s, such a machine could be operated at even higher speeds than the 80 mm/s currently used in step cut processing to provide even more improved throughput in the wafer dicing process.

It should be noted that, in step cutting, the first blade 20 is usually significantly wider and stronger than that of the trailing blade 22, typical figures are 55 μm vis-a-vis 45 μm. This is because the thin film layers may contain for example Tantalum which is an extremely strong material. Given the ability of a laser to cut material such as Tantalun without any danger of breaking, in the preferred embodiment of the present invention, the laser beam diameter is set of 30 μm so reducing overall street width. This in turn increases the overall available functional area of the wafer so enabling extra dies to be fabricated on a given wafer and so increasing yield.

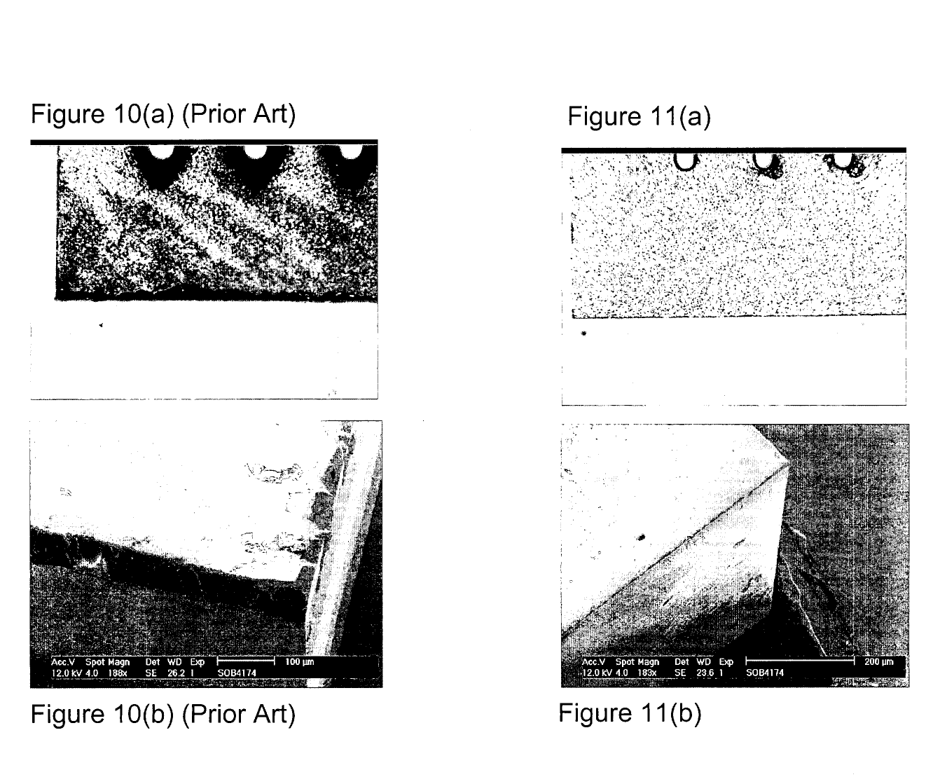

As evidence of the qualitative utility of the present invention, FIGS. 10(a) and 10(b) are a photograph and a scanning electron microscope (SEM) image respectively of a printhead processed according to a prior art single blade cutting process running at 80 mm/s. FIGS. 10(a) and 10(b) illustrate chipping on the back side of the printhead. FIGS. 11(a) and 11(b) are a corresponding photograph and a SEM image respectively of a printhead processed according to a preferred embodiment of the present invention running at the same saw cutting speed of 80 mm/s. It can therefore be seen that there is evidently less chipping at the sides of the print head than in the prior art.

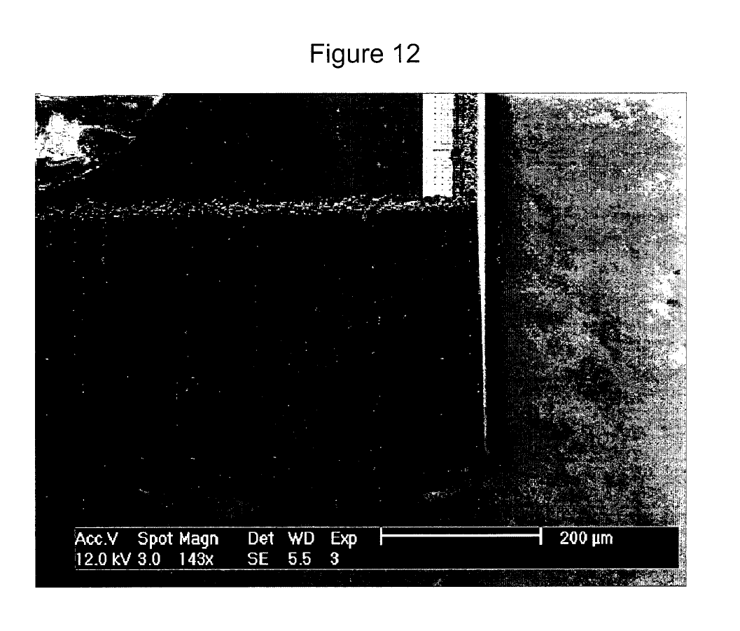

FIG. 12 is a more detailed SEM image of the printhead of FIG. 11(b) in reverse. Here the laser processing of the thin film layer is evident from the sputtered surface at the upper edges of the wafer. This does not continue through the depth of the wafer and so it is clear that some other form of processing has been performed after the laser processing to completely dice the wafer.

1. A method of dicing a wafer into a plurality of dies, said wafer comprising a substrate having a surface on which at least one thin film layer is formed, the method comprising the steps of:
laser cutting a line in the wafer to at least the depth of the at least one thin film layer; and
saw cutting along said line in the wafer to dice the wafer.

2. A method according to claim 1 wherein a plurality of lines are cut.

3. A method according to claim 2 wherein said lines comprise streets, corresponding to the edges of the dies along which the wafer is diced.

4. A method according to claim 1 wherein said dies are laser processed to define functional elements of said dies.

5. A method according to claim 4 wherein said dies comprise respective printheads for inkjet printers and wherein said printheads are laser processed to define ink slots in said dies.

6. A method according to claim 4 wherein said laser cutting step is performed during said laser processing of said functional elements.

7. A method according to claim 4 wherein said laser cutting step is performed after said laser processing of said functional elements.

8. A method according to claim 2 wherein said laser cutting step comprises cutting two or more parallel lines in the wafer at a given time.

9. A method according to claim 2 wherein said saw cutting step comprises cutting two or more parallel lines in the wafer at a given time.

10. A method according to claim 1 wherein said laser cutting step and said saw cutting step are performed in tandem.

11. A method according to claim 2 wherein said laser cutting step comprises successively directing a diode-pumped solid-state pulsed UV laser beam towards the lines in the wafer to etch away the at least one thin film layer in the vicinity of said lines.

12. An apparatus for dicing a wafer into a plurality of dies, said wafer comprising a substrate having a surface on which at least one thin film layer is formed, said apparatus comprising:
a laser source arranged to cut a line in the wafer to at least the depth of the thin film layer; and
a saw cutter arranged to cut along said line in the wafer to dice the wafer.

13. An apparatus according to claim 12 wherein said laser source is arranged to direct one or more laser beams in advance of one or more respective saw cutting blades.

14. A die comprising a substrate on which at least one thin film layer is formed, said at least thin film layer having being cut by a laser source to delineate the edges of the die in a wafer dicing process and the remainder of the substrate having being cut by a saw cutter along the edges of the die to separate said die from said wafer.

15. A print cartridge comprising a print head comprising a die according to claim 14.
